(19) United States
(12) Patent Application Publication
(10) Pub. No.: US 2002/0114624 A1
(43) Pub. Date: Aug. 22, 2002

(54) Power source control device of camera

(76) Inventors: Cheng-Yu Lin, Taichung Hsien (TW); Chun-Chieh Chen, Taichung (TW); Wen-Chuan Yang, Taichung (TW); Hui-Ying Wang, Taichung (TW); De-Jeng Li, Chang Hua (TW); Chun-Yi Lu, Taichung (TW)

Correspondence Address: BROWDY AND NEIMARK, P.L.L.C., 624 NINTH STREET, NW, SUITE 300, WASHINGTON, DC, 20001-5303, US

(21) Appl. No.: 09/785,212

(22) Filed: Feb. 20, 2001

(51) Int. Cl. G03B 17/00

(52) U.S. Cl. 396/85

(57) ABSTRACT

A camera power source control device comprises a press switch and a mechanical start switch. The press switch is disposed on one circuit located between the camera power source and a zoom cylinder control motor such that the circuit is connected at the time when the press switch is pressed, thereby driving the control motor to extract the zoom cylinder to locate at a predetermined position. The circuit is disconnected when the press switch is not pressed. The mechanical start switch is disposed on other circuit located between the camera power source and the zoom cylinder control motor and is formed of a first contact electric piece and a second contact electric piece, which are separated from each other at the time when the zoom cylinder is retracted to a closed position. The two contact electric pieces are in contact with each other at the time when the zoom cylinder is extracted to locate at a standby position.

### FIELD OF THE INVENTION

The present invention relates generally to a camera, and more particularly to a power source control device of the camera.

### BACKGROUND OF THE INVENTION

The conventional automatic cameras (non-mechanical cameras) are turned off electronically or mechanically. If the camera is turned off electronically, the system retract the lens sinking cylinder. The display circuit is turned off. On the surface, the camera is not in use. However, the system of the camera consumes a relatively small amount of power to keep the camera in a standby state. In addition to the electronic control, the camera is provided with a mechanical control by which the standby system circuits are turned off manually, thereby resulting in the closed state of the camera in its entirety. As a result, the power consumption of the camera is completely stopped. However, this brings about inconvenience in using the camera. In addition, there is a limited space in a miniaturized camera for installing a mechanical means to control the power source. In other words, there is a technical problem.

### SUMMARY OF THE INVENTION

The primary objective of the present invention is to provide a power source control device capable of turning off completely and automatically the power of a camera at the time when the camera is shut off.

The camera power source control device of the present invention is mounted on the camera to control the power source circuit of the camera and is formed of a press switch and a mechanical start switch. The press switch is disposed on one circuit located between the camera power source and the zoom cylinder control motor. As the press switch is pressed, the circuit is connected such that the motor is driven to extract the zoom cylinder. When the press switch is not pressed, the circuit is disconnected. The mechanical start switch is disposed on another circuit which is located between the camera power source and the zoom cylinder control motor. When the zoom cylinder is retracted into a closed position, the mechanical start switch is disconnected. The mechanical start switch is connected at the time when the zoom cylinder is extracted to be in a standby state.

### BRIEF DESCRIPTION OF THE DRAWINGS

FIG. 1 shows a schematic view of the circuits of the present invention.

FIG. 2 shows a schematic view of the mechanical start switch of the present invention in the disconnected state.

FIG. 3 shows a schematic view of the mechanical start switch of the present invention in the connected state.

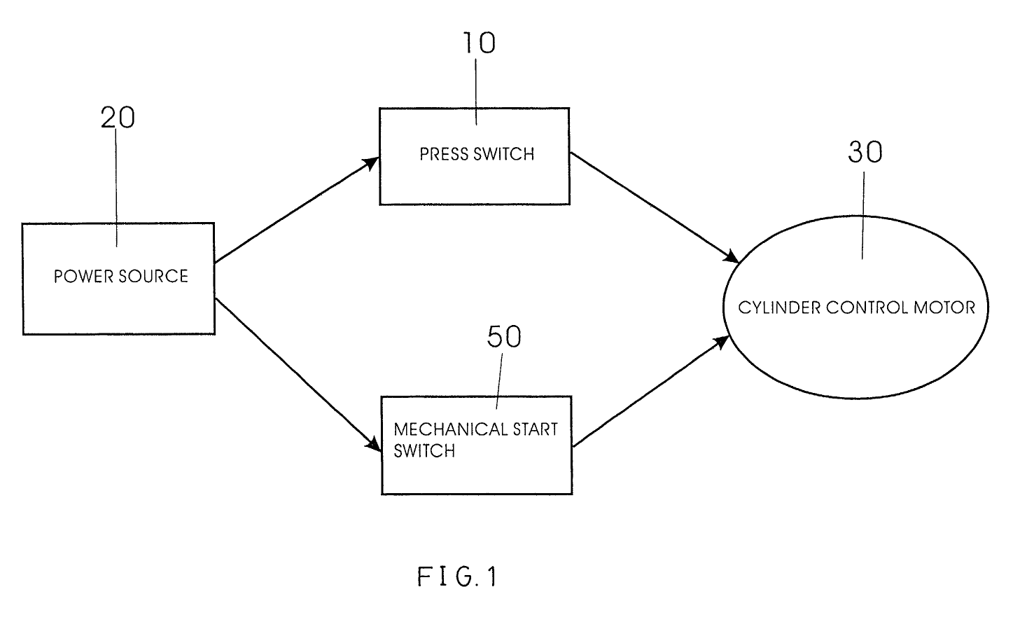

### DETAILED DESCRIPTION OF THE INVENTION

As shown in all drawings provided herewith, a camera power source control device of the present invention comprises a press switch 10 and a mechanical start switch 50.

The press switch 10 of the preferred embodiment of the present invention is a touch switch, which is disposed on one circuit located between a camera power source 20 and a zoom cylinder control motor 30. As the press switch 10 is pressed, the circuit is connected to allow the current of the camera power source 20 to flow to the zoom cylinder control motor 30. The motor 30 is thus driven to extract the zoom cylinder to a predetermined position. The circuit is disconnected when the press switch 10 is not pressed.

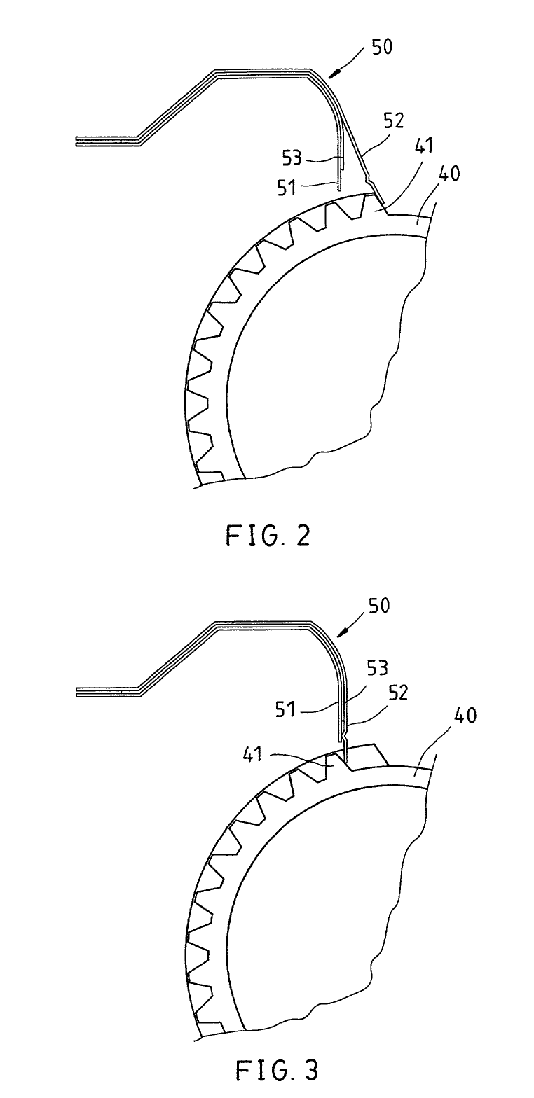

The mechanical start switch 50 is disposed on another circuit which is located between the camera power source 20 and the zoom cylinder control motor 30. The mechanical start switch of the preferred embodiment of the present invention is disposed at the outer side of a rack 41 of the zoom cylinder 40, as shown in FIG. 2. The mechanical start switch 50 comprises a first contact electric piece 51, a second contact electric piece 52, and an insulation pad 53 disposed between the first contact electric piece 51 and the second contact electric piece 52. The mechanical start switch is disposed in one side of the zoom cylinder 40 such that the first contact electric piece 51 and the second contact electric piece 52 are in contact with each other at the time when the mechanical start switch is in use, as shown in FIG. 3. As the zoom cylinder is retracted to the closed position, the mechanical start switch is disconnected, as shown in FIG. 2. When the zoom cylinder is extracted to the standby position, the mechanical start switch is in the connected state, as shown in FIG. 3.

As shown in FIG. 2, when the camera is in the closed state, the press switch 10 is pressed to cause the zoom cylinder 40 to retract to the final stationary position at which the rack 41 of the zoom cylinder is stopped at a predetermined position such that the tail end of the rack pushes the second contact electric piece 52 away. As a result, the second contact electric piece 52 is incapable of making contact with the first contact electric piece 51, thereby resulting in the disconnection between the camera power source 20 and the zoom cylinder control motor 30.

The camera is started by pressing the press switch 10 to connect the circuit located between the power source and the zoom cylinder control motor, thereby making the current available to the motor 30 via this circuit. The motor 30 is driven to extract the zoom cylinder 40, which is then turned to enable the rack 41 to move away from its stationary position. As a result, the second contact electric piece 52 is no longer urged by the rack 41, as shown in FIG. 3. The second contact electric piece 52 thus returns to its original position at which it is in contact with the first contact electric piece 51, thereby resulting in the connected state of the camera circuit. The camera is put into the closed state such that the motor 30 retracts the zoom cylinder 40 to enable the rack 41 to return to the stationary position at which the second contact electric piece 52 is pushed away from the first contact electric piece 51 by the rack 41, as shown in FIG. 2. The camera circuit is once again disconnected to conserve the power.

What is claimed is:

1. A camera power source control device mounted on the camera to control a power source circuit of the camera, said control device comprising:
a press switch disposed on one circuit located between the camera power source and a zoom cylinder control motor such that said circuit is connected to drive said control motor to extract said zoom cylinder control to a predetermined position at such time when said press switch is pressed; and
a mechanical start switch disposed on other circuit located between the camera power source and said zoom cylinder control motor such that said circuit is disconnected at such time when said zoom cylinder is retracted to a closed position, and that said circuit is connected at such time when said zoom cylinder is extracted to locate at a standby position.

2. The control device as defined in claim 1, wherein said mechanical start switch comprises a first contact electric piece and a second contact electric piece, which are disposed in one side of said zoom cylinder such that said second contact electric piece is moved by said zoom cylinder to make contact with said first contact electric piece at such time when the camera is in use, and that said second contact electric piece is moved by said zoom cylinder away from said first contact electric piece at such time when the camera is in the closed state.

3. The control device as defined in claim 2, wherein said first contact electric piece and said second contact electric piece are disposed in one side of a rack of said zoom cylinder.

4. The control device as defined in claim 3, wherein said first contact electric piece and said second contact electric piece are disposed in one side of one end of said rack of said zoom cylinder.

5. The control device as defined in claim 2, wherein said first contact electric piece and said second contact electric piece are provided with an insulation pad disposed therebetween.
